(19) United States
(12) Patent Application Publication
(10) Pub. No.: US 2002/0083216 A1
(43) Pub. Date: Jun. 27, 2002

(54) Multi-platform command line interpretation

(75) Inventors: Peter Michael Hickson, North Baddesley (GB); Stephen David Pipes, Southampton (GB)

Correspondence Address: IBM Corp, IP Law, Route 134/Kitchawan Road, Yorktown Heights, NY, 10598, US

(73) Assignee: International Business Machines Corporation, Armonk, NY

(21) Appl. No.: 10/013,222

(22) Filed: Dec. 10, 2001

(30) Foreign Application Priority Data
Dec. 21, 2000 (GB) 0031206.6

(51) Int. Cl. G06F 9/46; G06F 9/00

(52) U.S. Cl. 709/319

(57) ABSTRACT

A method, computer system and computer software product are provided to provide multi-platform command line interpretation.

A Java shell program on a computer system takes commands inputted into the system, in a foreign operating system (OS), if necessary splits, multiple commands into individual commands and then translates, these commands into native OS commands for execution, on the computer system in the native OS. The program has lists of commands in all supported operating systems and translation is carried out by comparing commands in the inputted foreign OS with these lists of commands to establish a native OS equivalent command and this equivalent command is passed to and processed by the computer systems native OS.

### FIELD OF THE INVENTION

The present invention relates generally to computer operating systems and particularly to a method, system and software product for providing multi-operating-system command line interpretation.

### BACKGROUND OF THE INVENTION

Every computer uses an operating system (OS), which is a program that functions as an interface between the user and the computer hardware. Most computer operating systems (OSs) have a command line based interface which can be used to access most or all of the functions of the operating system. Examples of such functions include file system functions such as copying, merging, and deleting of files, execution of system and user programs, browsing command history etc.

However, there are many different operating systems, e.g. MS-DOS, UNIX, IBM OS/2, Linux, Windows NT. The commands which the user needs to enter to cause the computer to perform functions differ from OS to OS and indeed some operating systems provide multiple commands for the same function.

Thus, a user who needs to work with more than one OS needs to become familiar with more than one set of commands in order to be able to work efficiently on these multiple OSs. Also, moving to a completely new OS requires the user to learn another set of commands, many of which have subcommands (or flags) which modify the default behaviour of the command.

A software product called the MKS Toolkit (Registered Trade Mark), produced by Mortice Kern Systems Inc, provides an implementation of various commands normally found on the Unix family of OSs, allowing these commands to be used on other OSs such as Windows and OS/2. MKS, however, supports only a single input syntax (Unix) and provides an operating system specific implementation of that command without translating the command to the corresponding equivalent command of the computer's native OS. By a computer's native OS is meant the operating system with which the computer is set up to run for operation.

Clearly it would be advantageous to have a system or method which would enable a user to operate on a computer system utilising OS commands with which he is familiar, irrespective of whichever, different, native OS is used by the computer.

### SUMMARY OF THE INVENTION

According to one aspect of the present invention, a method of implementing foreign operating system (OS) commands on a computer system having a native OS, comprising the steps of:

storing lists of commands for a plurality of OSs, including the native OS, together with information identifying equivalent commands in the different lists;

comparing an inputted command with the commands of the stored lists of commands to attempt to identify an equivalent command of the native OS; and

outputting an identified equivalent command for processing by the native OS or, if no equivalent command is identified, outputting the unrecognised command for it to be utilised, if possible, in its unchanged form by the computer system.

According to a second aspect of the present invention, a computer system having a native OS is provided, the computer system comprising:

storage means storing lists of commands for a plurality of OSs, including said native OS, together with information identifying equivalent commands in the different lists;

comparing means for comparing a user inputted command with the commands of the stored lists of commands to attempt to identify an equivalent command in the native OS; and

means for outputting an identified equivalent command for processing using the native OS or, if no equivalent command is identified for outputting the unrecognised command, for use in its unchanged form.

According to a third aspect of the present invention a computer software product is provided, comprising a computer-readable medium on which program instructions and information are stored, which instructions and information, when read by a computer having a native OS, provide a method for the computer to implement foreign OS commands on the computer, the method comprising the steps of:

storing lists of commands for a plurality of OSs, including the native OS, together with information identifying equivalent commands in the different lists;

comparing an inputted command with the commands of the stored lists of commands to attempt to identify an equivalent command of the native OS; and

outputting an identified equivalent command for processing by the native OS or, if no equivalent command is identified, outputting the unrecognised command for it to be utilised, if possible, in its unchanged form by the computer system.

Whilst many of the features of the invention may be hardware or firmware implemented it is advantageous for the invention to be implemented by a software program to be used on a computer system without, normally, requiring any special or onerous hardware modification. The program should be written in a programming language that is supported by the system on which it is to be used and should preferably be capable of supporting threads. Without being capable of supporting threads, the program would have difficulty handling multiple piped commands efficiently.

The program could be written in a number of different programming languages but, in the presently preferred embodiment, the Java language is used. Java is a platform-independent programming language which supports threading and is therefore an ideal choice, but not a requirement, for a program of this type.

Such an implementing program, particularly a Java Shell (or JShell) program, provides an advantageous multi-platform facility to allow a user to enter the same commands on all OS's by converting the command, entered by the user into the computer, into the equivalent command in the syntax of the native OS of the computer. It is to be noted that the native OS does not have to support a command-line interface in order for the JShell program to operate.

A benefit of this is that shell scripts can be written for one OS and be run on a plurality of other OSs that support the implementing program. This will save time and effort normally spent translating a shell script from one platform to another.

The program maintains a list of commands or Translator Table (TranslatorTable) for all supported operating systems, including acceptable flags, and uses these lists to identify the user's intended equivalent command in the native OS.

Preferably the method or system allows a user to specify (in a configuration file) foreign OSs in his chosen order of preference, for comparison with inputted commands, and the program will use this order of preference in conjunction with the lists of commands to identify the exact command (in command syntax terms) before translating it into the equivalent command in the native OS running on the machine. Thus, if a match is not found in the list for the first preferred foreign OS, then the list for the second preferred choice of OS (if specified) is queried, and so on. As specified above, any command or subcommand, for which a match is not found, is passed directly to the operating system without being translated.

On many OSs a command line may consist of numerous individual commands chained together by means of ‘pipes’, such that the output from one individual command is used as the input stream to another, thereby allowing long chains of interrelated commands to be constructed.

In the preferred embodiment of the invention, where a command line contains multiple commands piped together the program will attempt to translate the individual commands separately (using the rules described above), then will pass the resulting commands (whether modified by the translation process or not) through to the native operating system to be executed as separate OS processes. The program will handle the input and output streams of these processes to ensure that the commands are executed in the correct order and, where appropriate, that the output from each process is passed as input to the next process in the appropriate sequence to ensure that the components of the resulting command are executed in the same order as specified in the original command.

### BRIEF DESCRIPTION OF THE DRAWINGS

A preferred embodiment of the invention will now be described in detail by way of example only with reference to the following drawings:

FIG. 1 is a block diagram of an example of a computer system in which the aspects of the invention may be practised;

FIG. 2 is a flowchart representing the operational processes of the aspects of the invention;

FIG. 3 is a flowchart for a translator/interpreter component of FIG. 2;

FIG. 4 is a flowchart for a command processing component of FIG. 2; and

FIG. 5 shows diagrammatically the translation of a command inputted in a foreign OS syntax.

### DETAILED DESCRIPTION

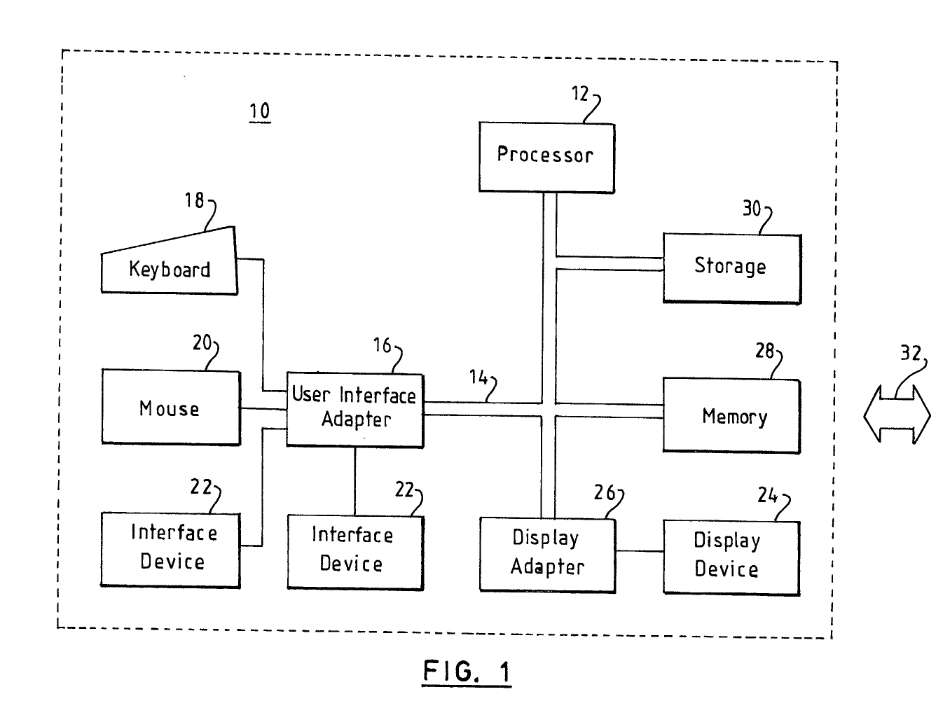

Referring to the drawings, FIG. 1 illustrates a representative workstation hardware environment in which the present invention may be practised. The environment of FIG. 1 comprises a representative single user computer workstation 10, such as a personal computer, including related peripheral devices. The workstation 10 includes a microprocessor 12 and a bus 14 employed to connect and enable communication between the microprocessor 12 and the components of the workstation 10 in accordance with known techniques. The workstation 10 typically includes a user interface adapter 16, which connects the microprocessor 12 via the bus 14 to one or more interface devices, such as a keyboard 18, mouse 20, and/or other interface devices 22, which can be any user interface device, such as a touch sensitive screen, digitised entry pad, etc. The bus 14 also connects a display device 24, such as an LCD screen or monitor, to the microprocessor 12 via a display adapter 26. The bus 14 also connects the microprocessor 12 to memory 28 and long-term storage which can include a hard drive, diskette drive, tape drive, etc.

The workstation 10 may communicate with other computers or networks of computers (not shown), for example via a communications channel or modem 32. Alternatively, the workstation 10 may communicate with such other computers using a wireless interface at 32, such as a CDPD (cellular digital packet data) card. The workstation 10 may be associated with such other computers in a LAN or a wide area network (WAN), or the workstation 10 can be a client in a client/server arrangement with another computer, etc. Or, the workstation 10 may operate as a stand-alone device, not connected to a network. All of these configurations, as well as the appropriate communications hardware and software, are known in the art.

Software programming code which embodies the present invention is typically accessed by the microprocessor 12 of the workstation 10 (or of a server computer from which workstation 10 may request delivery of a file, when the present invention operates in a networking environment) from long-term storage media 30 of some type, such as a CD-ROM drive or hard drive. The software programming code may be embodied on any of a variety of known media for use with a data processing system, such as a diskette, hard drive, or CD-ROM. The code may be distributed on such media, or may be distributed to users from the memory or storage of one computer system over a network of some type to other computer systems for use by users of such other systems. Alternatively, the programming code may be embodied in the memory 28, and accessed by the microprocessor 12 using the bus 14. The techniques and methods for embodying software programming code in memory, on physical media, and/or distributing software code via networks are well known and will not be further discussed herein.

The workstation 10 has a native operating system (OS) which provides the environment in which a user can execute programs. Whatever OS this is, it will involve specific OS commands that are peculiar to that OS. The present invention, which in the preferred embodiment is implemented as computer software, enables a user to enter commands in the syntax of another OS (foreign OS) which will then be translated or interpreted into the native OS commands to be processed by the workstation 10.

In the preferred embodiment, the invention is implemented in the form of a JShell program which may be stored in the long term storage 30 or may be inputted via one of the interfaces 22. The stored or inputted program includes read-only lists or Translator Tables of different OS commands for comparison with inputted foreign OS commands during operation of the software program.

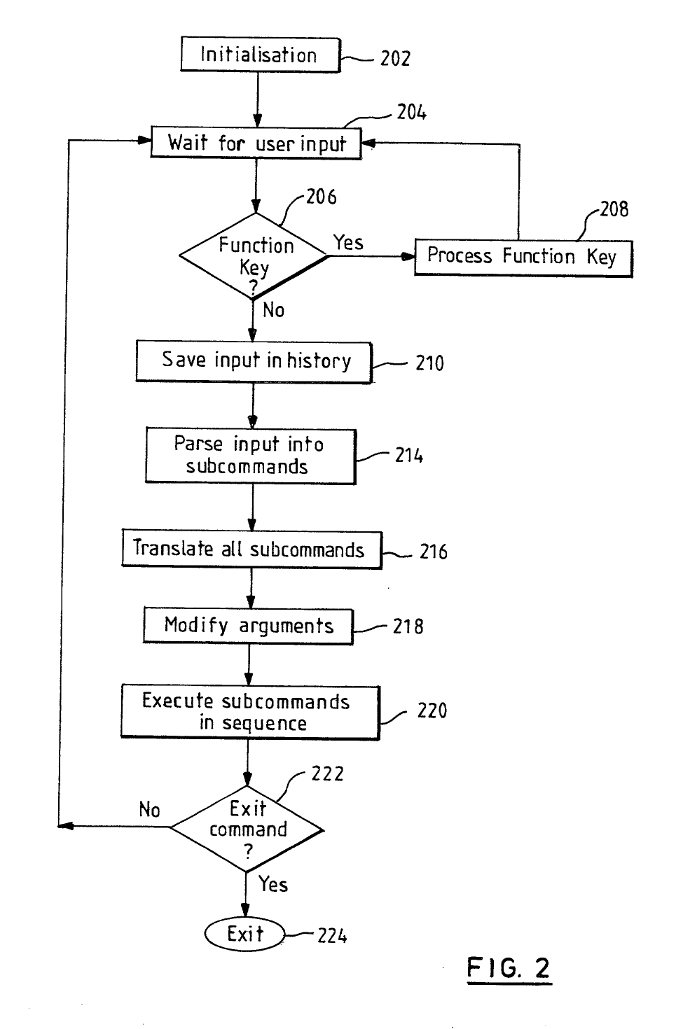

The flowchart of FIG. 2 provides an overview of the operation of a software program for carrying out the aspects of the invention to enable an operator to enter commands into a computer in a foreign OS, have the commands translated into the native OS and have them performed on the computer.

In the preferred embodiments, the program is a Jshell program written in Java which can be utilised on any computer system incorporating a Java Virtual Machine.

The program incorporates lists of commands or translator table (TranslatorTable) for different OSs including the native OS and this translator table is utilised by the program to establish the native OS command equivalent to an inputted foreign command.

A document “cmdlist” (command list) specifies the functionality of every command in a TranslatorTable. When a developer is creating a TranslatorTable, this document may be referenced in order to determine where each of the OS commands may be added in the TranslatorTable command list.

Every TranslatorTable has a command list, although it is very likely that no command list will be fully populated—most OSs will simply not provide enough commands to satisfy every entry in the cmdlist specification. For this reason, it is also possible that for an entered foreign OS command, no native OS command may be found because there is no equivalent available in the native OS TranslatorTable. The likelihood of this possibility arising is effectively determined by the the TranslatorTable's population, e.g. a nearly fully populated TranslatorTable will provide translations for most foreign OS commands entered.

A user may specify a specific order of preference for the program to use in its search for an equivalent Native OS command. For example, if a user is most used to writing commands in MS-DOS or UNIX, then he may specify in a set-up configuration that the program should first check to see if an entered command is in a MS-DOS command TranslatorTable and, if not found, secondly check to see if it is in the TranslatorTable of UNIX commands and so on.

When the program is launched the first step 202 is initialisation of the program which consists of reading the configuration file and determining the native OS of the host computer. As indicated above, the configuration file will contain any user preferences for the translation process.

After initialisation, the system waits for user input at step 204. Any input is checked in step 206 to see whether it is a function key or special-case input string which may need to be treated differently from command input strings. Should the input be a function key or special-case input, this input is processed in step 208, e.g. The function key input may require a previous command to be read from history storage and then displayed.

Any command input that is not a function key input, or any command that is read from history following a function key input, is stored in history in step 210 and then, if necessary, parsed into separate subcommands in step 214.

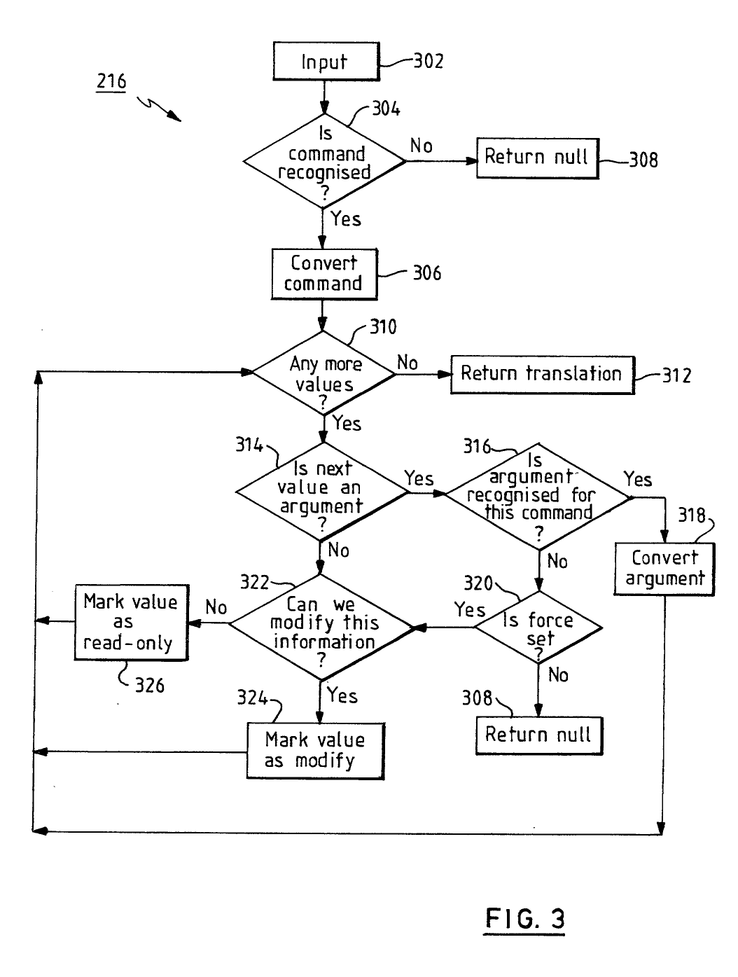

Translation of the subcommands then takes place in step 216 and this step is described in more detail below, with reference to FIG. 3. Following translation, some subcommands may have arguments that require to be modified and this is effected at step 218.

As explained above, the translation process will try each Translator table in turn (in the order specified by the user in the configuration set-up or in a default order if the user has not made an order specification) to attempt to translate a foreign OS command into a native OS command. If the end of the Translator Table hierarchy is reached without translating, then the command is passed unchanged to the native OS (unless ‘force’ is set, as explained hereafter in relation to FIG. 3).

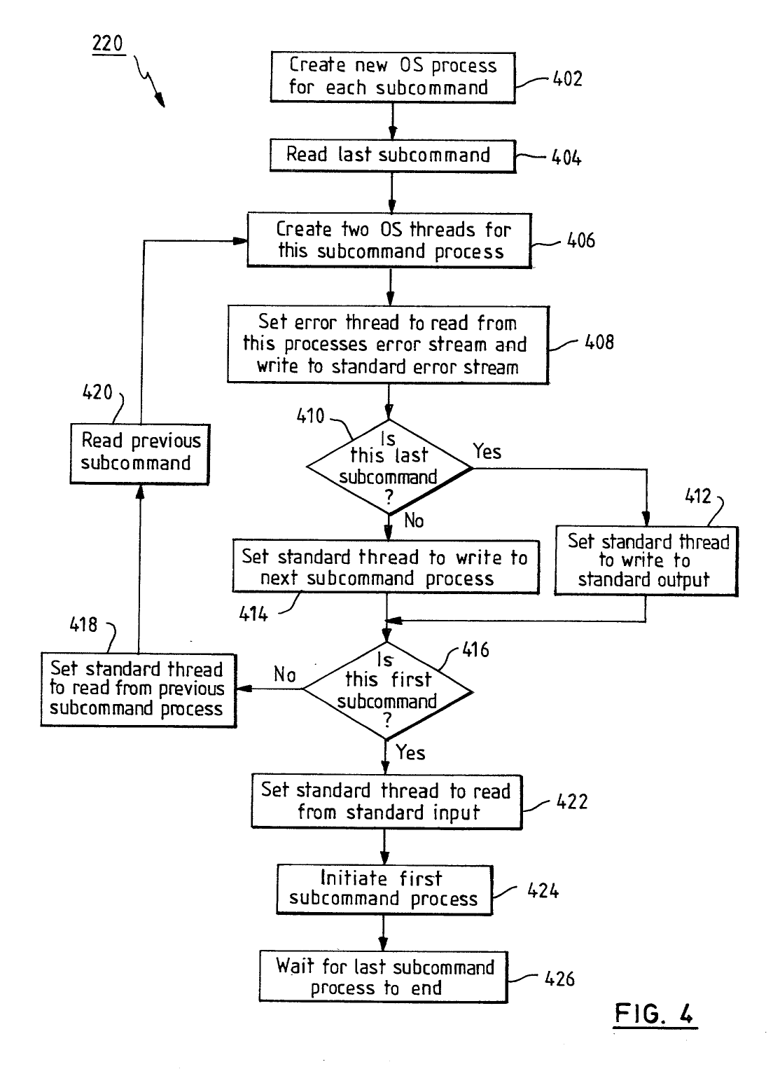

The subcommands are then executed at step 220, which is also described hereafter in more detail, with reference to FIG. 4.

In step 222, a check is made to see whether an exit command has been entered and, if so, exit from the program takes place in step 224. If not, the process returns to step 204 to stand by and await any user input.

With this arrangement, a user running a computer with, for example, a Linux OS may enter foreign OS commands, originally derived on a foreign OS, such as MS-DOS. The commands are entered into the JShell and passed to be dealt with by the Translator section, which will convert the MS-DOS commands into Linux commands, assuming that equivalents are available for the native (Linux) OS. The result of this conversion is then ordered (i.e. each separate command string may be reordered so that its flags and parameters are in the correct syntax order, but in the case of multiple ‘piped’ commands the overall sequence of commands will not be changed ) so that the translated command is in an appropriate state for the native OS. The command resulting from the translation can then be executed by the native OS.

FIG. 3 is a flowchart of the translation operation of the Command Translator step, step 216, in FIG. 2. The Translator is used to convert incoming commands or shell scripts written for a foreign OS into the equivalent commands for the native OS. It also provides information regarding ordering of OS commands and arguments and whether or not additional information is required in order for the command to execute on the native OS, such as a filename.

The primary function of the Translator is the conversion of the incoming foreign OS commands, as depicted in FIG. 3.

As shown, a command to be translated is input at step 302 and in step 304 is compared with the stored Translator Table lists of foreign OS commands. The method or system allows a user to specify (in a configuration file) a list of one or more foreign OS's in his chosen order of preference and the program will use this in conjunction with the lists of commands to identify the exact command (in command syntax terms) before translating it into the equivalent command in the native OS running on the machine. Thus, if a match is not found in the list for the first preferred foreign OS, then the list for the second preferred choice of foreign OS (if specified) is queried, and so on.

If the command is not recognised, a null return is initiated in step 308. However, if the command is recognised the command is converted in step 306 into the tabulated equivalent command in the native OS. A check is made in step 310 to see if the command has any or any more values that need consideration. If not, a translation of the code into the native OS is returned to the main Jshell program logic in step 312. If the command has a value to consider, this is checked to see if it is an argument and, if so, a check is made in step 316 to see if the argument is recognised for this command. A recognised argument is converted in step 318 and the process returns to step 310 to check for further values which would then be processed in the same way.

Should there be a value which is not an argument, a check is made in step 322 to see if the information can be modified (i.e. is modifiable). For example, the line

ls -l readme.txt

contains one command, one argument and one additional bit of information, which is the filename. This extra bit of information will be tagged as “Modifiable” since it will need to be expanded by a later process in order for the native OS to fully understand its meaning—in this example by fully qualifying its filename as

/home/MyDocs/readme.txt

So, once it has been modified the entry will look like

ls -l /home/MyDocs/readme.txt

and the command (ls) will know exactly where the file is]. Therefore, following the Translation step, consideration must be given to modifying any arguments marked as modifiable.

Thus, in order for a command to execute correctly, it is essential that the information being passed is correctly formed. On one OS, the format of a filename could be d:\MyDocs\myfile.txt, whilst on another OS, the same filename could be represented as /home/MyDocs/myfile.txt. As the two are clearly not the same, a modification needs to be made.

However, the TranslatorTable is concerned with only two aspects of the translation process

1. The structure of the information being entered (for example “command argument filename”)

2. The translation between the foreign OS command (and arguments) being entered and the equivalent native OS command (and arguments).

Should the entry information not be of the correct structure (check 1) then it may not be translated.

If the entry information is of the expected structure then it may be translated.

For example, given the input

ls -l /home/MyDocs/myfile.txt

assuming that the command and arguments (check 2) translated correctly, we may be left with

dir /w /home/MyDocs/myfile.txt

So the input is both correctly formed and has been successfully translated by the TranslatorTable but to finish the conversion, the filename must be translated or modified.

Since the TranslatorTable has knowledge of the structure of this command (so it is expecting a filename as the third token) it can mark it as “modifiable” and return the result to the supervisory JShell process. It is the responsibility of this process to modify the filename accordingly, as it will have additional information such as the current working directory.

An example of a non-modifiable token could be a web address (e.g. http://www.ibm.com). No matter what the native OS is, this token will not be modified.

Information that can be modified is, thus, so marked in step 324 and the process returns to step 310. Whereas, information which cannot be modified is marked as read-only and the process then returns to step 310.

If in step 316 the argument is not recognised for the command, a check is made in step 320 to see if the argument force is set. (A user can set force on by selecting the relevant option in the configuration file that is read when the JShell initialises.)

A force option allows a foreign OS command to be translated even if any one of the arguments is not recognised. Obviously, the unrecognised argument cannot in this case be translated directly into its native OS equivalent and is passed unchanged.

For example,

ls -l -e (AIX command)

is a command with two arguments. The first argument is recognised and the second is not and so normally the current TranslatorTable would return null (read as “cannot translate entry”). However, with force set, the command and first argument will be translated in the same way as normal but the second argument will not be translated because there is no equivalent and CRITICALLY the translated result is returned (rather than a null).

When, in step 320, it is found that force has been set, a check as to the possibility of modification is made in step 322 and the value marked in step 324, if it can be modified, or alternatively in step 322 it is marked as read-only, prior to returning to step 310. When the argument is not recognised for the command and no force has been set, a null is returned in step 308.

When the procedure has been carried out for all values, the translation of the command, with argument as appropriate, is returned in step 312.

With regard to command arguments, where appropriate the translator looks for three types of argument:—

1. Arguments that expect a parameter, e.g. ls--width=50, where width is the argument and 50 is the parameter. The translator must be made aware of such an argument if arguments are combined, e.g. Ls -lrt is the combined equivalent of ls -l -r -t. If the translator knows that the current argument is expecting a parameter, it will not attempt to split into further arguments which would otherwise result in width=50 being split.

2. Arguments that may be modified, e.g.

ls /home/user/* (AIX command)

dir d:\user\* (Windows NT equivalent)

This is necessary since Windows NT will not understand the syntax of an AIX file structure and vice versa. If the user does not specify an absolute filename e.g.

ls * (AIX command)

then, before the translator is passed this information, the rest of the filename structure will be automatically added, based on current environment settings

ls * (AIX) becomes

ls/home/user/* (AIX—after the system adds the working directory) and then

dir d:\user\* (Windows NT equivalent) after translation.

Thus, the resulting output may contain additional information required by the underlying operating system.

3. Arguments that may not be modified, e.g.

Echo Hello, World! (AIX command)

Echo Hello, World! (Windows NT equivalent)

Here the argument Hello, World! May not be modified by the translator since it has exactly the same meaning on any platform as it does in the original.

After the translation of the commands, the Jshell program handles the execution of commands as shown in FIG. 4. On many OSs a command line may consist of numerous individual commands (these are referred to as subcommands in the text used in FIG. 4) chained together by means of ‘pipes’, where the output from one individual command is used as the input stream to another, thereby allowing long chains of interrelated commands to be constructed.

Where a command line contains multiple commands piped together the program will attempt to translate the individual commands separately (using the rules described above), then will pass the resulting commands (whether modified by the translation process or not) through to the native operating system to be executed as separate OS processes. The program will handle the input and output streams of these processes to ensure that the commands are executed in the correct order and that the output from each process is passed as input to the next process in the sequence where appropriate to ensure the components of the resulting command are executed in the same order as specified in the original command.

This allows the use of pipes to chain together multiple commands even if the native operating system does not support the pipe command. Furthermore this allows the Jshell program the opportunity (not exploited in the current design as herein described) to modify the output from one command before passing it as input to the next, for example if a relative filename needed to be converted to a fully-qualified filename.

As shown in step 402 of FIG. 4, the program first creates a separate new OS process for each subcommand. Then the last subcommand is read in step 404 and two output system threads, a standard thread and an error thread, are created in step 406. In step 408 the error thread is set to read from the process error stream and to write this to the standard error stream. Step 410 checks whether the process is the last subcommand and then for the last subcommand, in step 412, the process standard thread is set to write to the standard output for the system.

The process then moves to step 416, where a check is made see if the subcommand is the first subcommand—which it would be if there were only a single command. For the last subcommand of a multiple subcommand, this would not be the case and in step 418 its standard thread would be set to read the output from the previous subcommand process. In step 420, the previous subcommand process is read and following this two OS threads are created in step 406 for this subcommand's process. As for the last subcommand process, in step 408, the error thread is set to read from the error stream of this process and to write to the standard error stream. The check to see if the subcommand is the last subcommand in step 410 will result in the answer no and in step 414 the command's standard thread will be set to write to the next subcommand process—for this subcommand this will be to the last subcommand.

If there are more than two subcommands, the cycle will be repeated through steps 416, 418, 420, 406, 408, 410, 414 and 416 to repeat the setting up procedure for each of the subcommands until step 416 detects that a subcommand is the first subcommand. When that is detected, the standard thread for the first subcommand process is set to read from the standard input, in step 422. Thus, each subcommand process, apart from the first, obtains its input from the previous subcommand process output and each subcommand process, apart from the last, writes its output to the next subcommand process input. The standard input is connected to provide the input to the first subcommand process and the standard output receives the output of the last subcommand process.

Once all the threads are set up for the subcommand processes, in reverse order from the last to the first, the first subcommand process is initiated in step 424 and processing continues until the end of the last subcommand process is detected in step 426

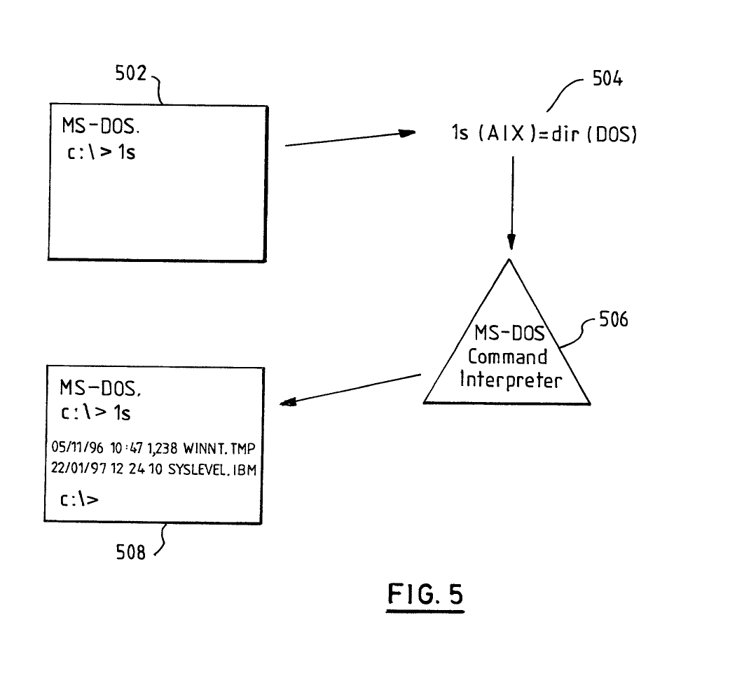

FIG. 5 Shows diagrammatically at 101, a simple Linux command “ls”, inputted into a system running with a MS-DOS OS. The Jshell Program according to the invention recognises this command, at 502, as being the equivalent of the MS-DOS OS “dir” command to list the files in the present directory. The command is thus translated into the native OS command “dir”, at step 504, and the command passes to the MS-DOS command interpreter, 506, and the output is displayed, at 508, in the native OS format.

Two further examples of commands inputted in a foreign OS and the outputs in a different native OS produced by the system or method of the present invention are given below:

### EXAMPLE 1

Input AIX OS command

>cat HelloWorld | grep“Hello” | tee hello.out

Output equivalent command in Windows NT

>type HelloWorld |findstr “Hello” | tee hello.out

Here “cat” is translated to “type” and “grep” to “findstr” but there is no translation available for “tee” so it is passed through unchanged (resulting in a run-time error from the Windows NT operating system).

### EXAMPLE 2

Input AIX OS command

>java HelloWorld | grep “Hello”

Output equivalent command in Windows NT

>java HelloWorld | findstr “Hello”

Here again “grep” is translated to “findstr” and there is no translation for “java” which is passed through unchanged. However, if there is a java virtual machine installed on this system the command will run successfully.

(Java is a trademark of Sun Microsystems Inc.)

1. A method of implementing foreign operating system (OS) commands on a computer system having a native OS, comprising the steps of:
storing lists of commands for a plurality of OSs, including the native OS, together with information identifying equivalent commands in the different lists;
comparing an inputted command with the commands of the stored lists of commands to attempt to identify an equivalent command of the native OS; and
outputting an identified equivalent command for processing by the native OS or, if no equivalent command is identified, outputting the unrecognised command for it to be utilised, if possible, in its unchanged form by the computer system.

2. A method according to claim 1, wherein the method is contained in a software program containing instructions and data, with the program being written in any software language supported by the computer system with which it is to be used.

3. A method according to claim 2, wherein the software program is written in a programming language that is supported on multiple platforms.

4. A method according to claim 3, wherein the programming language supports threads.

5. A method according to claim 4, wherein the software program is written in Java, forming a Jshell program.

6. A method according to claim 1, wherein the lists of commands comprises the commands, including flags, for all supported OSs and wherein a user may specify a chosen order of preference for comparison of a command with the foreign OSs, whereby, if a command match is not found in the list of commands for the first preferred foreign OS, a match is sought in the list of the next preferred foreign OS commands and so on until a matching command is found to enable an equivalent command to be selected or until no match is found in any of the lists.

7. A method according to claim 4, wherein, if the inputted command line consists of a plurality of individual commands “piped” together, the method further comprises the steps of translating the individual commands separately and then passing the resulting commands through to the native operating system to be executed as separate OS processes.

8. A method according to claim 7 further comprising the steps of the program arranging the handling of multiple command input and output streams so as to ensure that the commands are executed in the correct order and, where appropriate, that the output from each process is passed as input to the next process in the appropriate sequence to ensure that the components of the resulting command are executed in the same order as specified in the original command.

9. A method according to claim 1, wherein if an individual command contains a part which needs to be modified to be expressed differently in the native operating system, this is determined in the command comparison and translation process and the program arranges for the subsequent necessary modification prior to execution of the command in the native OS.

10. A method according to claim 9, wherein if a command can only be partially translated into a native OS command, a null return will be issued and the command left untranslated unless a force instruction is applied in which event the partially translated command, possibly with modification, will be passed to be processed in the native OS.

11. A method of implementing foreign operating system (OS) commands on a computer system having a native OS, comprising the steps of:
storing lists of commands for a plurality of OSs, including the native OS, together with information identifying equivalent commands in the different lists;
comparing an inputted command with the commands of the stored lists of commands to attempt to identify an equivalent command of the native OS; and
outputting such an identified equivalent command for processing by the native OS.

12. A computer system having a native OS, the computer system comprising:
storage means storing lists of commands for a plurality of OSs, including said native OS, together with information identifying equivalent commands in the different lists;
comparing means for comparing a user inputted command with the commands of the stored lists of commands to attempt to identify an equivalent command in the native OS; and
means for outputting an identified equivalent command for processing using the native OS or, if no equivalent command is identified for outputting the unrecognised command, for use in its unchanged form.

13. A computer system according to claim 12, wherein the storage means, comparison means and outputting means are under the control of a software program, in a language supported by the computer system and enabling the computer system to operate using listed foreign OS commands inputted into the computer system.

14. A computer system according to claim 13, wherein the software program is written in a programming language that is supported on multiple platforms.

15. A computer system according to claim 14, wherein the programming language supports threads.

16. A computer system according to claim 15, wherein the software program is written in Java, forming a Jshell program.

17. A computer system according to claim 14, wherein the lists of commands comprises the commands, including flags, for all supported OSs and wherein a user may specify a chosen order of preference for comparison of a command with the foreign OSs, whereby, if a command match is not found in the list of commands for the first preferred foreign OS, a match is sought in the list of the next preferred foreign OS commands and so on until a matching command is found to enable an equivalent command to be selected or until no match is found in any of the lists.

18. A computer system according to claim 15, wherein, if the inputted command line consists of a plurality of individual commands “piped” together, the program will attempt to translate the individual commands separately and then will pass the resulting commands through to the native operating system to be executed as separate OS processes.

19. A computer system according to claim 18 wherein the program arranges the handling of multiple command input and output streams so as to ensure that the commands are executed in the correct order and, where appropriate, that the output from each process is passed as input to the next process in the appropriate sequence to ensure that the components of the resulting command are executed in the same order as specified in the original command.

20. A computer system according to claim 14, wherein if an individual command contains a part which needs to be modified to be expressed differently in the native operating system, this is determined in the command comparison and translation process and the program arranges for the subsequent necessary modification prior to execution of the command in the native OS.

21. A computer system according to claim 20, wherein if a command can only be partially translated into a native OS command, a null return will be issued and the command left untranslated unless a force instruction is applied in which event the partially translated command, possibly with modification, will be passed to be processed in the native OS.

22. A computer software product, comprising a computer-readable medium on which program instructions and information are stored, which instructions and information, when read by a computer having a native OS, provide a method for the computer to operate using foreign OS commands input to the computer, the method comprising the steps of:
storing lists of commands for a plurality of OSs, including the native OS, together with information identifying equivalent commands in the different lists;
comparing an inputted command with the commands of the stored lists of commands to attempt to identify an equivalent command of the native OS; and
outputting an identified equivalent command for processing by the native OS or, if no equivalent command is identified, outputting the unrecognised command for it to be utilised, if possible, in its unchanged form by the computer system.

23. A computer software product, according to claim 22, wherein the program instructions are written in a programming language that is supported on multiple platforms.

24. A computer software product according to claim 23, wherein the programming language supports threads.

25. A computer software product according to claim 24, wherein the program instructions are written in Java, forming a Jshell program.

26. A computer software product according to claim 23, wherein the lists of commands comprises the commands, including flags, for all supported OSs and wherein a user may specify a chosen order of preference for comparison of a command with the foreign OSs, whereby, if a command match is not found in the list of commands for the first preferred foreign OS, a match is sought in the list of the next preferred foreign OS commands and so on until a matching command is found to enable an equivalent command to be selected or until no match is found in any of the lists.

27. A computer software product according to claim 24, wherein, if the inputted command line consists of a plurality of individual commands “piped” together, the program instructions will attempt to translate the individual commands separately and then will pass the resulting commands through to the native operating system to be executed as separate OS processes.

28. A computer software product according to claim 27 wherein the program instructions arrange the handling of multiple command input and output streams so as to ensure that the commands are executed in the correct order and, where appropriate, that the output from each process is passed as input to the next process in the appropriate sequence to ensure that the components of the resulting command are executed in the same order as specified in the original command.

29. A computer software product according to claim 23, wherein if an individual command contains a part which needs to be modified to be expressed differently in the native operating system, this is determined in the command comparison and translation process and the program instructions arrange for the subsequent necessary modification prior to execution of the command in the native OS.

30. A computer software product according to claim 29, wherein if a command can only be partially translated into a native OS command, a null return will be issued and the command left untranslated unless a force instruction is applied in which event the partially translated command, possibly with modification, will be passed to be processed in the native OS.
